(19) United States
(12) Patent Application Publication
(10) Pub. No.: US 2011/0242260 A1
(43) Pub. Date: Oct. 6, 2011

(54) OPTICAL HEAD AND IMAGE FORMING APPARATUS

(75) Inventors: Kenichi Komiya, Kanagawa-ken (JP); Koji Tanimoto, Shizuoka-ken (JP); Daisuke Ishikawa, Shizuoka-ken (JP); Hiroyuki Ishikawa, Shizuoka-ken (JP); Kazutoshi Takahashi, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/072,404

(22) Filed: Mar. 25, 2011

Related U.S. Application Data
(60) Provisional application No. 61/320,290, filed on Apr. 1, 2010.

(51) Int. Cl. B41J 2/435; F21V 3/00

(52) U.S. Cl. 347/224; 362/311.01; 362/311.02

(57) ABSTRACT

An optical head includes a light-emitting substrate that emits light, a lens that focuses the light emitted from the light-emitting substrate, a holder that hold the light-emitting substrate and the lens, and a drive circuit that includes an electric element fixed to at least one of the lens and the holder and drives the light-emitting substrate.

### CROSS-REFERENCE TO RELATED APPLICATION(S)

This application is based upon and claims the benefit of priority from: U.S. provisional application No. 61/320,289, filed on Apr. 1, 2010; the entire contents of which are incorporated herein by reference.

### FIELD

Embodiments described herein relate generally to an optical head and an image forming apparatus.

### BACKGROUND

An optical head emits light used for exposure of a photoreceptor. The optical head includes a light-emitting substrate, and the light-emitting substrate generates heat by the light emission. When the light-emitting substrate is continued to be used, since the light-emitting substrate is deteriorated by the heat or the like, it is necessary to replace the optical head. When a drive circuit of the optical head is fixed to the light-emitting substrate, there is a case where the drive circuit, together with the light-emitting substrate, is discarded.

### DESCRIPTION OF THE DRAWINGS

FIG. 1 is a view showing an inner structure of an image forming apparatus.

FIG. 2 is an outer appearance view of an optical printer head of a first embodiment.

FIG. 3 is a sectional view of the optical printer head of the first embodiment.

FIG. 4 is a front view of a light-emitting element and a glass substrate in the first embodiment.

FIG. 5 is a schematic view of apart of an optical printer head including a bottom emission type light-emitting element in the first embodiment.

FIG. 6 is a schematic view of a part of an optical printer head including a top emission type light-emitting element in the first embodiment.

FIG. 7 is a view showing a drive circuit of an optical printer head.

### DETAILED DESCRIPTION

According to one embodiment, an optical head includes a light-emitting substrate that emits light, a lens that focuses the light emitted from the light-emitting substrate, a holder that holds the light-emitting substrate and the lens, and a drive circuit that includes an electric element fixed to at least one of the lens and the holder and drives the light-emitting substrate.

### First Embodiment

A first embodiment will be described with reference to the drawings.

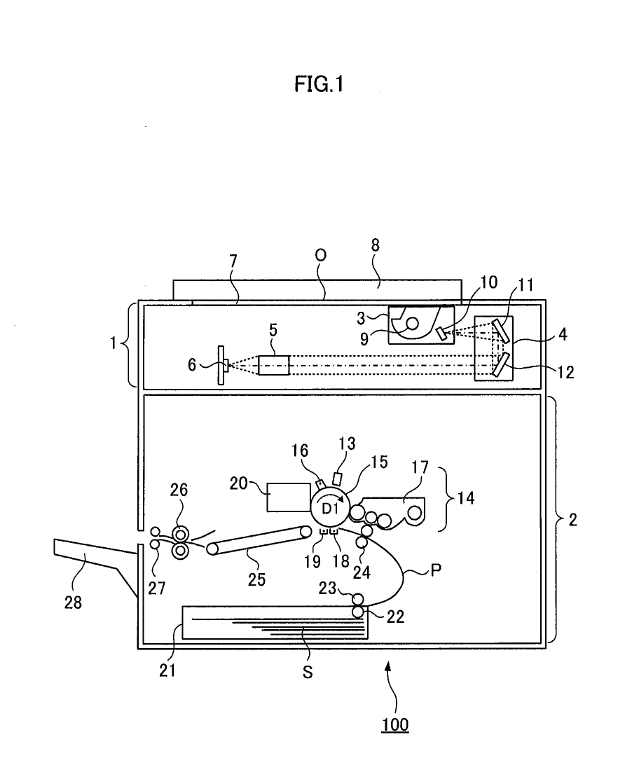

FIG. 1 is a view showing an inner structure of an image forming apparatus. The image forming apparatus 100 includes a scanner part 1 and a printer part 2. The scanner part 1 reads an image of a document O. The printer part 2 forms an image on a sheet.

The document O is placed on a document table glass 7. The read surface of the document O is directed downward and contacts the document table glass 7. A cover 8 rotates between a position where the document table glass 7 is closed and a position where the document table glass 7 is opened. When the cover 8 closes the document table glass 7, the cover 8 presses the document O to the document table glass 7.

A light source 9 emits light to the document O. The light of the light source 9 passes through the document table glass 7 and reaches the document O. The reflected light from the document O is reflected by mirrors 10, 11 and 12 in this order and is guided to a condensing lens 5. The condensing lens 5 focuses the light from the mirror 12, and forms an image on a light receiving surface of a photoelectric conversion element 6. The photoelectric conversion element 6 receives the light from the condensing lens 5 and converts it into an electric signal (analog signal).

An output signal of the photoelectric conversion element 6 is subjected to a specified signal processing, and then is outputted to an optical printer head 13 as an optical head. The specified signal processing is a processing of generating image data (digital data) of the document O. As the photoelectric conversion element 6, for example, a CCD sensor or a CMOS sensor can be used.

A first carriage 3 supports the light source 9 and the mirror 10, and moves along the document table glass 7. A second carriage 4 supports the mirrors 11 and 12, and moves along the document table glass 7. The first carriage 3 and the second carriage 4 independently move, and keep the light path length from the document O to the photoelectric conversion element 6 constant.

When the image of the document O is read, the first carriage 3 and the second carriage 4 move in one direction. While the first carriage 3 and the second carriage 4 move in the one direction, the light source 9 emits the light to the document O. The reflected light from the document O forms an image on the photoelectric conversion element 6 by the mirrors 10 to 12 and the condensing lens 5. The image of the document O is sequentially read one line by one line in the movement direction of the first carriage 3 and the second carriage 4.

The printer part 2 includes an image forming part 14. The image forming part 14 forms an image on a sheet S conveyed from a paper feed cassette 21. The plural sheets S received in the paper feed cassette 21 are separated one by one by a conveyance roller 22 and a separation roller 23, and are sent to the image forming part 14. The sheet S reaches a register roller 24 while moving along a conveyance path P. The register roller 24 moves the sheet S to a transfer position of the image forming part 14 at a specified timing.

A conveyance mechanism 25 moves the sheet S on which the image is formed by the image forming part 14 to a fixing unit 26. The fixing unit 26 heats the sheet S and fixes the image to the sheet S. A paper discharge roller 27 moves the sheet S on which the image is fixed to a paper discharge tray 28.

An operation of the image forming part 14 will be described.

The optical printer head 13, a charging unit 16, a developing unit 17, a transfer charger 18, a peeling charger 19 and a cleaner 20 are disposed around a photoconductive drum 15. The photoconductive drum 15 rotates in a direction of an arrow D1.

The charging unit 16 charges the surface of the photoconductive drum 15. The optical printer head 13 exposes the charged photoconductive drum 15. The optical printer head 13 causes plural light beams to reach exposure positions of the photoconductive drum 15.

When the light beams from the optical printer head 13 reach the photoconductive drum 15, the potential at the exposure portion is lowered, and an electrostatic latent image is formed. The developing unit 17 supplies a developer to the surface of the photoconductive drum 15 and forms a developer image on the surface of the photoconductive drum 15.

When the developer image reaches the transfer position by the rotation of the photoconductive drum 15, the transfer charger 18 transfers the developer image on the photoconductive drum 15 to the sheet S. The peeling charger 19 peels the sheet S from the photoconductive drum 15. The cleaner 20 removes a developer remaining on the surface of the photoconductive drum 15.

While the photoconductive drum 15 rotates, the formation of the electrostatic latent image, the formation of the developer image, the transfer of the developer image and the cleaning of the remaining developer image can be continuously performed. That is, the operation of forming the image on the sheet S can be continuously performed.

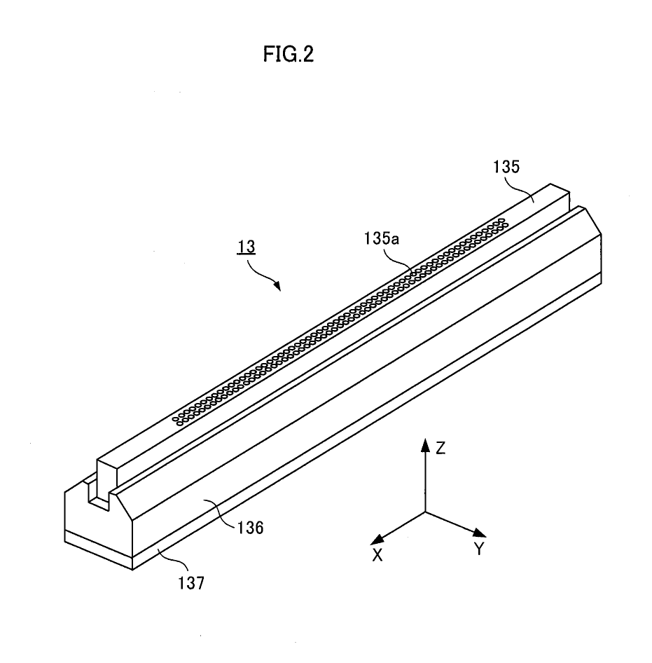

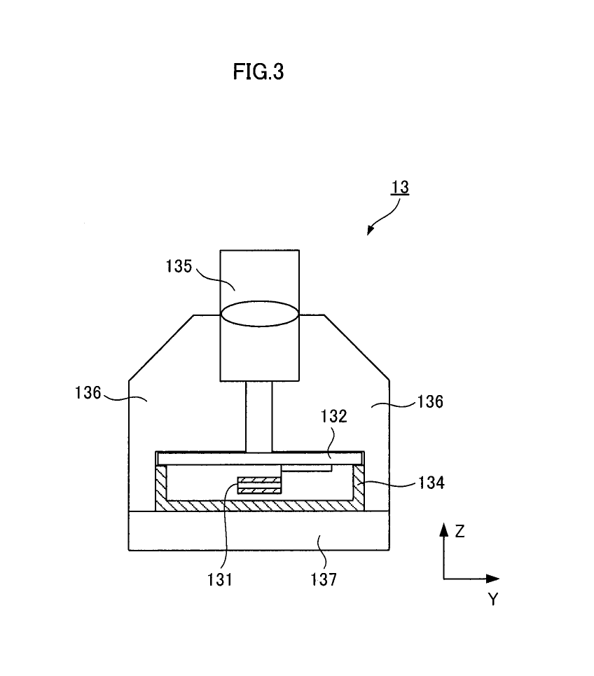

A structure of the optical printer head 13 will be described. FIG. 2 is an outer appearance view of the optical printer head 13, and FIG. 3 is a sectional view of the optical printer head 13. In FIG. 2 and FIG. 3, an X axis, a Y axis and a Z axis are axes perpendicular to each other. Also in the other drawings, the relation among the X axis, the Y axis and the Z axis is the same.

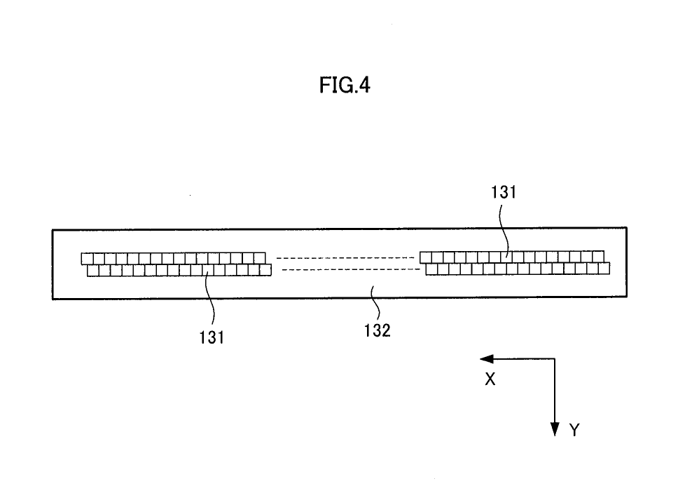

Light-emitting elements 131 are laminated on a glass substrate 132. As shown in FIG. 4, the plural light-emitting elements 131 are provided on the glass substrate 132. The plural light-emitting elements 131 are arranged in the longitudinal direction (X direction) of the glass substrate 132. Lines of the plural light-emitting elements 131 arranged in the X direction are arranged in the Y direction.

The glass substrate 132 is substantially transparent, and allows light to pass through. Although the glass substrate 132 is used in this embodiment, a substrate transparent to light can be used as well as the glass substrate 132. For example, instead of the glass substrate 132, a substrate formed of resin can be used.

The glass substrate 132 is fixed to a lens holder 136 as a holder body. For example, the glass substrate 132 can be fixed to the lens holder 136 by using an adhesive.

The lens holder 136 holds a SELFOC lens array 135. As shown in FIG. 2, the SELFOC lens array 135 includes plural SELFOC lenses 135a, and the plural SELFOC lenses 135a are arranged side by side along the longitudinal direction (X direction) of the glass substrate 132. In this embodiment, lines of the plural SELFOC lenses 135a arranged in the X direction are arranged in the Y direction.

The glass substrate 132 and a sealing member 134 form a receiving space for the light-emitting elements 131. The sealing member 134 is fixed to the lens holder 136 and a cover 137. The cover 137 is fixed to the lens holder 136. The light-emitting elements 131, the glass substrate 132 and the sealing member 134 are received in a space formed between the lens holder 136 and the cover 137.

Lights emitted from the light-emitting elements 131 are incident on the SELFOC lens array 135. The light emitted from each of the light-emitting elements 131 is incident on the corresponding SELFOC lens 135a.

The SELFOC lens array 135 focuses the plural lights (diffused lights) from the plural light-emitting elements 131 and causes them to reach exposure positions of the photoconductive drum 15. Spot lights with a desired resolution are formed at the exposure positions.

FIG. 5 is a schematic view showing a part of the optical printer head 13.

In this embodiment, a so-called bottom emission type organic EL element is used as the light-emitting element 131.

The light-emitting element 131 includes an anode 131a, a cathode 131b and a light-emitting layer 131c. The anode 131a is a transparent electrode for injecting a hole into the light-emitting layer 131c. The anode 131a can be formed of, for example, ITO (Indium Tin Oxide). The cathode 131b is an electrode for injecting an electron into the light-emitting layer 131c. The light-emitting layer 131c includes an organic material, and exists between the anode 131a and the cathode 131b.

When a DC voltage or a DC current is applied to the anode 131a and the cathode 131b, the anode 131a injects a hole into the light-emitting layer 131c. The cathode 131b injects an electron into the light-emitting layer 131c. In the light-emitting layer 131c, an electron state of an organic molecule is changed from a ground state to an excited state by the recombination of the hole and the electron.

The excited state is a higher energy state than the ground state. Since the excited state is an unstable state, the electron state of the organic molecule is returned to the ground state from the excited state. When the electron state is changed from the excited state to the ground state, energy is released and a light emitting phenomenon occurs in the light-emitting layer 131c.

The light generated in the light-emitting layer 131c is directed to the anode 131a and the cathode 131b. Since the anode 131a is the transparent electrode, the light from the light-emitting layer 131c passes through the anode 131a. The light directed to the cathode 131b is reflected by the cathode 131b, and is directed to the anode 131a. The light passing through the anode 131a passes through the glass substrate 132, and reaches the SELFOC lens array 135.

A transistor 131d as a switching element is laminated on the glass substrate 132, and is used to control the luminance of the light-emitting element 131. As the transistor 131d, for example, a TFT (Thin Film Transistor) can be used. Plural transistors 131d can be provided for the one light-emitting element 131.

When the light-emitting element 131 emits light, the light-emitting element 131 generates heat. The heat generated in the light-emitting element 131 is transmitted to the glass substrate 132. The heat transmitted to the glass substrate 132 is transmitted to the lens holder 136.

When the temperature rise of the light-emitting element 131 is suppressed, the deterioration of the light-emitting element 131 due to the heat can be suppressed, and the life of the light-emitting element 131 can be extended.

The light-emitting element 131 as the organic EL element is liable to be influenced by heat, the amount of light is halved by the temperature rise of the light-emitting element 131, and a luminance half period becomes short. In the optical printer head 13, in order to secure the required exposure amount, as compared with another equipment (for example, a display) for emitting light, an applied current is large, and the amount of self-heat generation is also large.

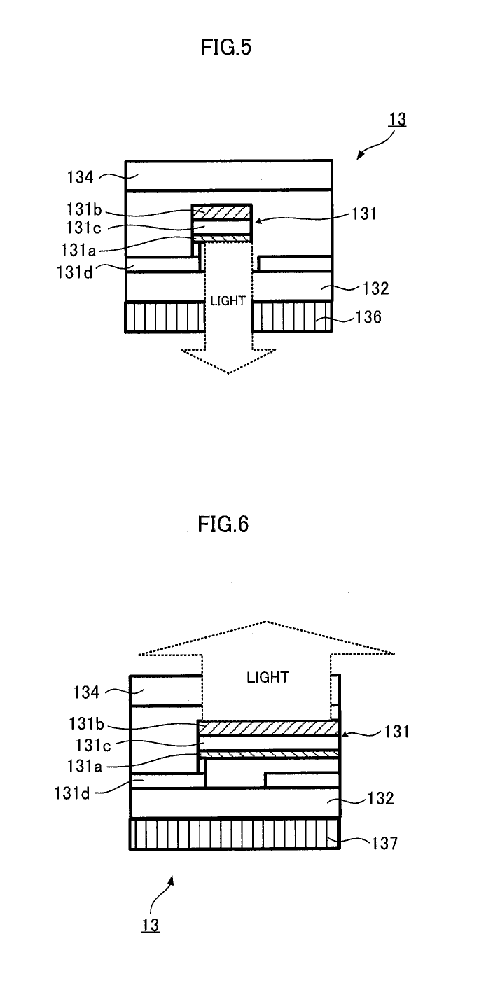

Although the light-emitting element 131 of this embodiment is the bottom emission type light-emitting element, a so-called top emission type light-emitting element can also be used. FIG. 6 is a schematic view of the optical printer head 13 using the top emission type light-emitting element.

In the bottom emission type light-emitting element 131, the anode 131a is the transparent electrode. However, in the top emission type light-emitting element 131, the cathode 131b is the transparent electrode. The cathode 131b as the transparent electrode can be formed of, for example, ITO (Indium Tin Oxide). When the cathode 131b is the transparent electrode, it is necessary to provide a metal for the cathode on an interface to an organic film.

Light generated in the light-emitting layer 131c is directed to the anode 131a and the cathode 131b. The light directed to the cathode 131b passes through the cathode 131b. The light directed to the anode 131a is reflected by the anode 131a and is directed to the cathode 131b. The sealing member 134 allows the light from the light-emitting element 131 to pass through. When the sealing member 134 is substantially transparent, the light can be emitted from the sealing member 134 without reducing the amount of light. The glass substrate 132 contacts the cover 137.

When the top emission type light-emitting element is used, since a block such as an electrode of a circuit is not disposed on the optical path, it is easy to ensure the area of light emission, and it is easy to ensure the amount of light.

In this embodiment, although the organic EL element is used as the light-emitting element 131, another light source can be used. For example, as the light-emitting element 131, an LED (Light Emitting Diode) can be used.

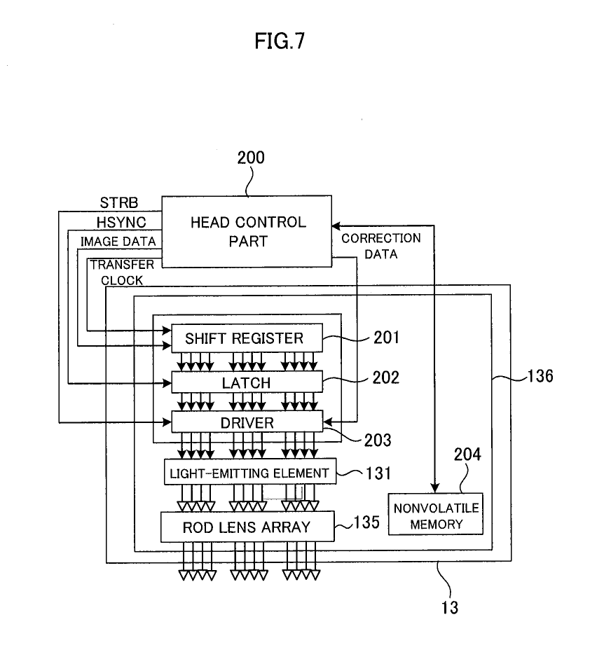

Next, a drive circuit of the optical printer head 13 will be described. FIG. 7 is a view showing a structure of the optical printer head 13 including the drive circuit of the optical printer head 13.

A head control part 200 controls driving of the optical printer head 13. A shift register 201 stores image data for one line. The head control part 200 outputs the image data for one line to the shift register 201 in synchronization with a transfer clock.

When the output of the image data to the shift register 201 is ended, the head control part 200 outputs a HSYNC (horizontal synchronizing signal) signal to a latch circuit 202. The latch circuit 202 receives the HSYNC signal and latches the image data for one line in the shift register 201.

When the head control part 200 outputs a STRB signal to a driver 203, the driver 203 supplies a current according to a corresponding pixel to a light-emitting element 131. The light-emitting element 131 emits light according to the value of the supplied current.

Since the STRB signal corresponds to the exposure time of the photoconductive drum 15, the exposure amount can be increased by adjusting (increasing) the output time of the STRB signal. The deterioration of sensitivity of the photoconductive drum 15 can be treated by increasing the exposure amount. That is, as the sensitivity of the photoconductive drum 15 becomes deteriorated, the exposure amount can be increased.

The driver 203 includes a register for correcting a current value supplied to the light-emitting element 131. Correction data for correcting the amount of light emitted from the light-emitting element 131 is written in the register of the driver 203. The current value outputted from the driver 203 is corrected by the correction data.

The amount of light reaching the photoconductive drum 15 from the light-emitting element 131 can vary by various variations of the optical printer head 13. The correction data is used to correct the variation in the amount of light reaching the photoconductive drum 15. The various variations of the optical printer head 13 include a variation in luminous efficiency between the plural light-emitting elements 131, a variation of the drive circuit to drive the respective light-emitting elements 131, a variation in refractive index distribution of the SELFOC lens array 135, a variation in arrangement of the SELFOC lenses 135a, and a variation in positional relation between the light-emitting element 131 and the SELFOC lens array 135. The correction data can be obtained by previous measurement in a manufacturing line or an adjustment line of the optical printer head 13.

A nonvolatile memory 204 stores the correction data. As the nonvolatile memory 204, for example, an EEPROM can be used.

The head control part 200 reads the correction data from the nonvolatile memory 204 at the start of the image forming apparatus 100. The head control part 200 writes the correction data into the register of the driver 203 at a specified timing before the start of an image forming operation, for example.

The measuring method of the correction data will be described. For example, in the manufacturing line or the adjustment line of the optical printer head 13, an optical sensor such as a CCD is used, and the light intensity distribution of respective pixels of the optical printer head 13 is measured. A current instruction value to the driver 203 is adjusted so that the light amounts of all pixels are within a specified range (for example, 40 nW±0.5%). A value for adjusting the current instruction value is the correction data, and is stored in the nonvolatile memory 204. The writing of the correction data into the nonvolatile memory 204 is performed by writing of the correction data compatible to the head control part 200.

The nonvolatile memory 204 is fixed to the lens holder 136. The nonvolatile memory 204 is connected to a wiring, and is, together with a part of the wiring, fixed to the lens holder 136. The wiring electrically connects the nonvolatile memory 204 and the head control part 200. As the wiring, for example, a flexible printed board, a flexible board or a flexible printed cable can be used.

As the method of fixing the nonvolatile memory 204 to the lens holder 136, the nonvolatile memory 204 can be fixed to the outer surface of the lens holder 136. As the outer surface of the lens holder 136, for example, an end face (see FIG. 2) of the lens holder 136 in the X direction can be used. When the nonvolatile memory 204 is fixed to the outer surface of the lens holder 136, a cover to cover the nonvolatile memory 204 can be used. The nonvolatile memory 204 can be protected by using the cover.

On the other hand, the nonvolatile memory 204 can also be embedded in the lens holder 136.

In this embodiment, although the nonvolatile memory 204 is fixed to the lens holder 136, the nonvolatile memory 204 can be fixed to the SELFOC lens array 135 or the cover 137.

When the nonvolatile memory 204 is fixed to the SELFOC lens array 135, the nonvolatile memory 204 can be fixed to a position deviated from the light path of the light emitted from the light-emitting element 131. The nonvolatile memory 204 can be fixed to the outer surface of the SELFOC lens array 135 or can be embedded in the SELFOC lens array 135.

In this embodiment, although the nonvolatile memory 204 is fixed to the lens holder 136 or the like, instead of the nonvolatile memory 204, or together with the nonvolatile memory 204, an electric element other than the nonvolatile memory 204 can be fixed to the lens holder 136 or the like. The electric element is an electric element constituting the drive circuit (see FIG. 7) of the optical printer head 13.

According to this embodiment, since the nonvolatile memory 204 is fixed to the lens holder 136, when the lens holder 136 and the glass substrate 132 are separated from each other, the lens holder 136 including the nonvolatile memory 204 can be reused. That is, a reusable component and a discarded component can be simply separated by only removing the glass substrate 132.

Although the deteriorated glass substrate 132 can not be reused, the lens holder 136 and the nonvolatile memory 204 are resistant to deterioration and can be reused. When the SELFOC lens array 135 is reused, the SELFOC lens array 135 can be cleaned.

Incidentally, in this embodiment, the fixing includes fitting into a socket or the like.

While certain embodiments have been described, these embodiments have been presented by way of example only, and are not intended to limit the scope of invention. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. An optical head comprising:
a light-emitting substrate that emits light;
a lens that focuses the light emitted from the light-emitting substrate;
a holder that holds the light-emitting substrate and the lens; and
a drive circuit that includes an electric element fixed to at least one of the lens and the holder and drives the light-emitting substrate.

2. The head of claim 1, wherein the electric element is fixed to the holder.

3. The head of claim 1, wherein the electric element is a memory that stores correction data for correcting an amount of emitted light of the light-emitting substrate.

4. The head of claim 3, wherein the memory is a nonvolatile memory.

5. The head of claim 2, wherein the electric element is fixed to an outer surface of the holder.

6. The head of claim 2, wherein the electric element is embedded in the holder.

7. The head of claim 1, further comprising a wiring which is connected to the electric element and a part of which is connected to at least one of the lens and the holder.

8. The head of claim 7, wherein the wiring is one of a flexible board, a flexible printed board and a flexible printed cable.

9. The head of claim 1, wherein the light-emitting substrate includes an organic EL element.

10. The head of claim 1, wherein the light-emitting substrate includes an LED element.

11. The head of claim 1, wherein the holder includes
a holder body to which the light-emitting substrate is fixed and which holds the lens, and
a cover that surrounds the light-emitting substrate together with the holder body.

12. An image forming apparatus comprising:
a photoreceptor;
a light-emitting substrate that emits light;
a lens that focuses the light emitted from the light-emitting substrate to the photoreceptor;
a holder that holds the light-emitting substrate and the lens;
a drive circuit that includes an electric element fixed to at least one of the lens and the holder and drives the light-emitting substrate; and
a developing unit that supplies a developer to the photoreceptor.

13. The apparatus of claim 12, wherein the electric element is fixed to the holder.

14. The apparatus of claim 13, wherein the electric element is fixed to an outer surface of the holder.

15. The apparatus of claim 13, wherein the electric element is embedded in the holder.

16. The apparatus of claim 12, wherein the electric element is a memory that stores correction data for correcting an amount of emitted light of the light-emitting substrate.

17. The apparatus of claim 16, wherein the memory is a nonvolatile memory.

18. The apparatus of claim 12, further comprising a wiring which is connected to the electric element and a part of which is fixed to at least one of the lens and the holder.

19. The apparatus of claim 12, wherein the light-emitting substrate includes an organic EL element.

20. The apparatus of claim 12, wherein the light-emitting substrate includes an LED element.
